(19) United States
(12) Patent Application Publication
(10) Pub. No.: US 2026/0017575 A1
(43) Pub. Date: Jan. 15, 2026

(54) HARVESTING PATH PLANNING SYSTEMS AND METHODS

(71) Applicant: Deere & Company, Moline, IL (US)

(72) Inventors: Stephen R. Corban, Geneseo, IL (US); Corey A. Akers, Highland Ranch, CO (US); Federico Pardina-Malbran, Fort Collins, CO (US); Ryan C. Russell, Orion, IL (US)

(73) Assignee: Deere & Company, Moline, IL (US)

(21) Appl. No.: 18/771,493

(22) Filed: Jul. 12, 2024

(51) Int. Cl. G06Q 10/047; B60W 10/04; B60W 10/20; G01C 21/00; G01C 21/36; G06Q 10/0639; G06Q 50/02

(52) U.S. Cl. CPC G06Q 10/047; B60W 10/04; B60W 10/20; G01C 21/3626; G01C 21/3804; G06Q 10/0639; G06Q 50/02

(57) ABSTRACT

One or more techniques and/or systems are disclosed for improving harvesting productivity, such as by harvesting path planning. This includes determining a harvest productivity for a plurality of areas of a field and determining off site transport availability for offloading and transport of the harvested crop for one or more harvester vehicles harvesting the field. Harvest productivity determination can be performed for the one or more harvester vehicles based on current and historical data for the plurality areas of the field, and the availability of vehicles for off site transport can be identified. Based on the productivity and the availability of vehicles, one or more predictive paths for the harvester are identified, and may be adjusted in response to changes in transport availability and/or changing site conditions.

### BACKGROUND

Agricultural machines are used to perform different operations, such as harvesting operations in a field. For example, harvester vehicles are used to harvest different crops, such as different types of grain crops. The harvester vehicles can also be fitted with different types of heads to harvest different types of crops. In operation, the harvester vehicles can operate in coordination with other vehicles, such as tractors pulling grain carts, transport trucks, etc., to harvest the crop. However, it can be difficult to coordinate the many different operations and movements during harvesting, which can affect the productivity of the overall harvest system.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for improving harvest production performance. In one implementation, a system can comprise an agricultural harvester configured to harvest a crop. Further, a controller can comprise a processor for processing instructions and data, and memory for storing the instructions and the data. The controller can be configured to identify crop transport availability during a harvesting operation, wherein the crop transport availability comprises data representing an out of field transport system characteristic. The controller can be further configured to identify a predictive harvesting path for the harvester based at least on the identified crop transport availability and a productivity performance index for at least a portion of a field in which the harvester is operating. In this implementation, the productivity performance index for at least a portion of the field is representative of a predicted harvest rate for the crop in a location in the field. Additionally, in this implementation, the predictive harvesting path is used to guide the harvester to an area of the field that will provide the improved harvest production performance based on the out of field transport system characteristic.

In another implementation of an example system, the out of field transport system characteristic comprises an availability of a grain cart to receive the harvested crop from the harvester, the grain cart availability comprising a current availability and a predicted availability.

In another implementation of the example system, the out of field transport system characteristic comprises an availability of a grain truck transport to receive the harvested crop from a grain cart, the grain truck availability comprising a current availability and a predicted availability.

In another implementation of the example system, the out of field transport system characteristic comprises a status of the transport system. In this implementation, the status comprises one or more of: a time for transporting the harvested crop transport off site; a time for grain truck availability after unloading of harvested crop off site; a wait time at harvested crop unloading site; and identified off site traffic impacts.

In another implementation of the example system, the out of field transport system characteristic comprises a rate of transport of the harvested crop off site.

In another implementation of the example system, the out of field transport system characteristic comprises a rate of transport by a grain cart of the harvested crop from the harvester to a grain transport truck.

In another implementation of the example system, the predicted harvest rate for the crop in a location in the field comprises an amount of harvested crop over an area, or amount of harvested crop over a period of time.

In another implementation of the example system, the predicted harvest rate for the crop in a location in the field comprises a mass of harvested crop per area or time, or volume of harvested crop per area or time.

In another implementation of the example system, the predictive harvesting path comprises a location in the field with a lower productivity performance index when the identified crop transport availability is lower, and the predictive harvesting path comprises a location in the field with a higher productivity performance index when the identified crop transport availability is higher.

In another implementation of the example system, the system can comprise a mapping subsystem that generates a field map to guide the harvester based on the predictive harvesting path.

In another implementation of the example system, the system can comprise a user display that displays the generated field map to an operator of the harvester.

In another implementation of the example system, the system can comprise a harvester control subsystem that controls the harvester based on the predictive harvesting path.

In another implementation of the example system, the harvester control subsystem can comprise one or more of: a harvester propulsion control and a harvester steering control.

In another implementation, a computer-based system for improving the harvest production performance, can comprise a processor for processing instructions and data, and memory for storing the instructions and the data. The system can further comprise a crop transport logistics module that identifies crop transport availability for a harvesting operation performed by at least one harvester in a field, wherein the crop transport availability is identified using data representative of the availability of one or more crop transport vehicles to offload harvested crop from the harvester during the harvesting operation. A harvester operation mapping module can identify a harvesting path for the harvester during the operation to provide a predicted crop harvesting rate that complements the identified crop transport availability, the a harvesting path for the harvester identified using a productivity performance index for at least a portion of a field, wherein the productivity performance index is representative of a predicted harvest rate for the crop in a location in the field. A harvester control module that guides the harvester to an area of the field that will provide the improved harvest production performance using the identified harvesting path for the harvester.

In another implementation of the computer-based system, the identified harvesting path for the harvester comprises a location in the field with a lower productivity performance index when the identified crop transport availability is lower, and the identified harvesting path for the harvester comprises a location in the field with a higher productivity performance index when the identified crop transport availability is higher.

In another implementation of the computer-based system, the identified crop transport availability comprises an availability of a grain cart to receive the harvested crop from the harvester, the grain cart availability comprising a current availability and a predicted availability.

In another implementation of the computer-based system, the identified crop transport availability comprises an availability of a grain truck transport to receive the harvested crop from a grain cart, the grain truck availability comprising a current availability and a predicted availability.

In another implementation of the computer-based system, the identified harvesting path for the harvester is used by a mapping subsystem that generates a field map to guide the harvester based on identified harvesting path.

In another implementation of the computer-based system, the system comprises a harvester control subsystem that controls the harvester based on the identified harvesting path, the harvester control subsystem comprising one or more of: a harvester propulsion control and a harvester steering control.

In another implementation, a system for improving harvest production performance can comprise an agricultural harvester configured to harvest a crop in a field during a harvesting operation. Further, a controller can comprise a processor for processing instructions and data, and memory for storing the instructions and the data. In this implementation, the controller configured to identify crop transport availability during a harvesting operation, wherein the crop transport availability comprises data representing an out of field transport system characteristic. The controller can be further configured to identify a predictive harvesting path for the harvester based at least on the identified crop transport availability and a productivity performance index for at least a portion of a field in which the harvester is operating.

In this implementation, the system can additionally comprise a harvester control module that guides the harvester to an area of the field that will provide the improved harvest production performance using the predictive harvesting path for the harvester. The harvester control module can comprise a mapping subsystem that generates a field map to guide the harvester based on the predictive harvesting path, and a harvester control subsystem that controls the harvester based on the predictive harvesting path. In this implementation, the productivity performance index for at least a portion of a field is representative of a predicted harvest rate for the crop in a location in the field. Further, the predictive harvesting path comprises a location in the field with a lower productivity performance index when the identified crop transport availability is lower, and the predictive harvesting path comprises a location in the field with a higher productivity performance index when the identified crop transport availability is higher.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a diagram illustrating a crop harvesting operation in a field according to an implementation.

FIG. 2 is a diagram of a harvester vehicle and illustrating crop harvesting according to an implementation.

FIG. 3 is another diagram illustrating a crop harvesting operation in a field according to an implementation.

FIG. 4 is a diagram of a harvester vehicle according to an implementation.

FIG. 5 is a functional block diagram of an agricultural harvester according to an implementation.

FIG. 6 is a diagram illustrating a field having a low yield area determined according to an implementation.

FIG. 7 is a process flow diagram of path planning according to an implementation.

FIG. 8 is a process flow diagram of yield prediction for a field according to an implementation.

FIG. 9 is an example of a method for performing yield prediction for a field according to an implementation.

FIG. 10 is an example of a method for harvesting path planning for a field according to an implementation.

FIG. 11 is a block diagram of an example computing environment suitable for implementing various examples.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific combine harvester vehicles for particular harvesting applications, such as for particular grain harvesting) to control movement of harvester vehicles and other vehicles that results in improved performance, such as increased harvested crop throughput. For example, one or more herein described examples allow for improved analysis and coordination of movement of vehicles within and relative to a field being harvested to increase the productivity of the overall harvest system (e.g., to maximize throughput of the harvest system).

In some implementations, harvesting production performance can be improved, for example, by planning one or more harvesting paths based on the availability of crop transport, and/or a productivity performance index for a one or more row portions of a field in which harvesting is taking place. As an example, a productivity performance index (e.g., a value) can be representative of a predicted harvest rate for the crop in a location in the field. A predicted harvest rate can be affected by myriad of characteristics, such as a type of crop, types of vehicles, number of vehicles in operation, machine characteristics (e.g., harvesting specifications of the harvester-speed, size, production rate, etc.), a size and shape of the field (e.g., a length of a harvest pass for a planned path), an agricultural characteristic (e.g., soil moisture, geology such as soil type, ground conditions, other environmental conditions that may affect harvest rate), and/or a crop characteristic (e.g., down crop or standing crop, lodged crop, leaning crop, crop moisture, grain quality (such as good grain or bad grain), crop state (such as density, or others conditions that may affect harvesting operations, etc.), a characteristic of the field (such as a harvested or unharvested state, obstructions in the field, traversable or non-traversable terrain or features), performance characteristics of the vehicles or operation (e.g. wait times, speeds, etc.) among others.

Further, in some implementations, the predictive harvesting path may improve harvesting production based on an out of field transport system characteristic. That is, crop transport availability during the harvesting operation may comprise data that is representative of some out of field transport availability, such as to take the harvested crop from the harvester to a storage or processing location. For example, one such characteristic can comprise an availability of a grain cart (e.g., or wagon, or the like, anything that can be used to move a crop in the field, or out of the field) to collect grain from the harvester, which may include current and predicted availability (e.g., will it be available to offload grain when the harvester is full or near full). Another such characteristic can comprise an availability of a grain truck (e.g., transport from field to off-site location) to receive the harvested crop from the grain cart, which may also include current and predicted availability (e.g., will the truck be available when the grain cart is full). Another such characteristic can comprise the status of a transport system, which may include the time for transporting the crop offsite, the time for grain truck availability after taking grain offsite, a wait time at an unloading site, and potential off site traffic impact (e.g., road conditions, traffic, accidents, etc.).

Other out of field transport system characteristics can comprise a rate of transport of the harvested crop offsite (e.g., time for transport, unload, and return for truck); a rate of transport of a grain cart from harvester to transport truck; and other conditions that may affect the harvest production times (e.g., that reduce wait times for the harvester, and improve actual harvesting times where the crop is actually being harvested).

For example, in some implementations, to increase or maximize the productivity of the harvest system (e.g., actual harvesting of the crop in the field), operation of the vehicles and other equipment used during harvesting is controlled using path planning for one or more harvester vehicles. As stated above, the predictive harvesting path for the harvester can be based on the productivity performance index and the availability of crop transport, where the identified harvesting path is conditioned to use the harvester in a most productive way for the provided conditions. For example, using current data (e.g., existing harvesting conditions) and historical data (e.g., previously identified yield/productivity areas in the field), as well as one or more other harvesting characteristics and/or predicted outputs a path can be planned to maximize the productivity of the harvest system In one example, lower yield/productivity areas of the field, or harvesting paths/passes can be harvested when trucks and carts are less available to receive and transport the harvested crop. In this way, the harvester is still being utilized for harvesting, but may not need to offload the crop as often. In contrast, those areas or paths in the field that are predicted to have a higher yield rate (e.g., more crop per distance or time) may be harvested during times when the grain carts and/or transport trucks are predicted to be available. In this way, the available out of field transport can be available to receive the offloaded crop from the harvester more often.

It should be appreciated that one or more examples described herein can be implemented in connection with any type of characteristic in the agricultural harvesting processing, including before processing of the crop, during processing of the crop, or after processing of the crop. That is, the present disclosure contemplates systems and arrangements used in processed and/or not processed agricultural environments or applications (e.g., processed crop applications or pre-processed crop applications).

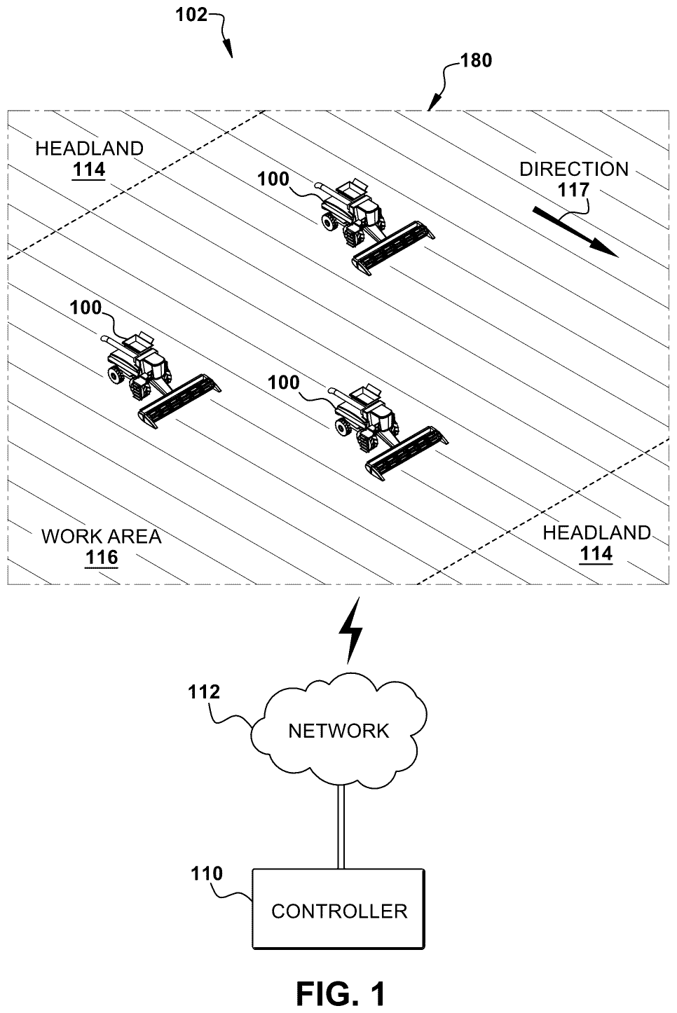

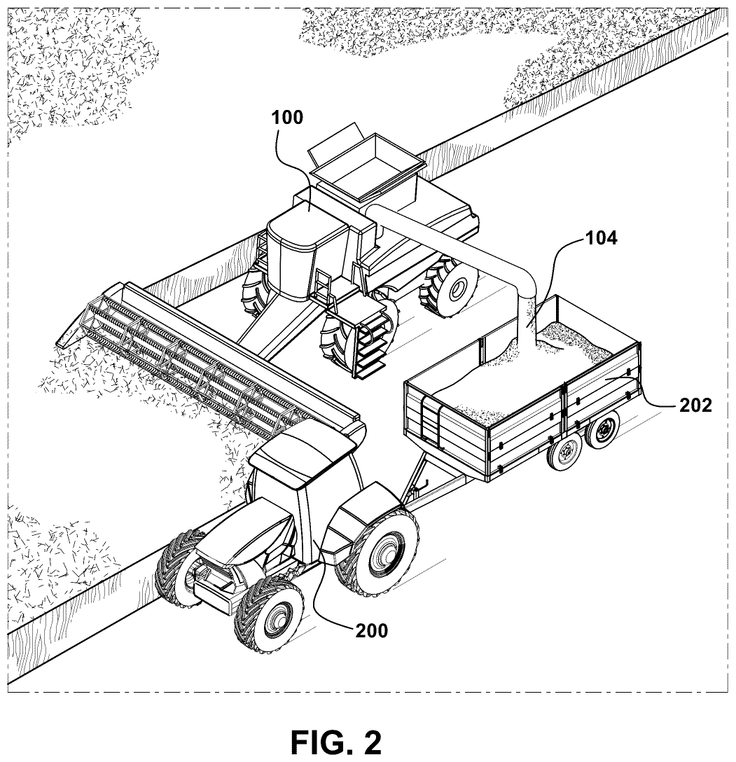

In one or more examples, coordination of vehicle movement within a field is provided using harvesting path planning as described in more detail herein. For example, as illustrated in FIGS. 1 and 2, path planning for one or more harvester vehicles 100 (e.g., combine harvesters) is used to coordinate harvesting operations with other vehicles, illustrated as a tractor 200 and a cart 202 (e.g., a grain cart). It should be appreciated that the examples described herein can be used for path planning and vehicle movement coordination with any type of vehicle, such as any type of vehicle used during crop harvesting. Various implementations of the present disclosure may be used for controlling movement of one or more vehicles, such as harvesters, combines, tractors, mowers, automobiles, trucks, utility vehicles, or any other vehicles intended to provide coverage of a specific land areas. The path planning and control operations can be performed using different controllers, such as in a single computing system or a distributed computing system.

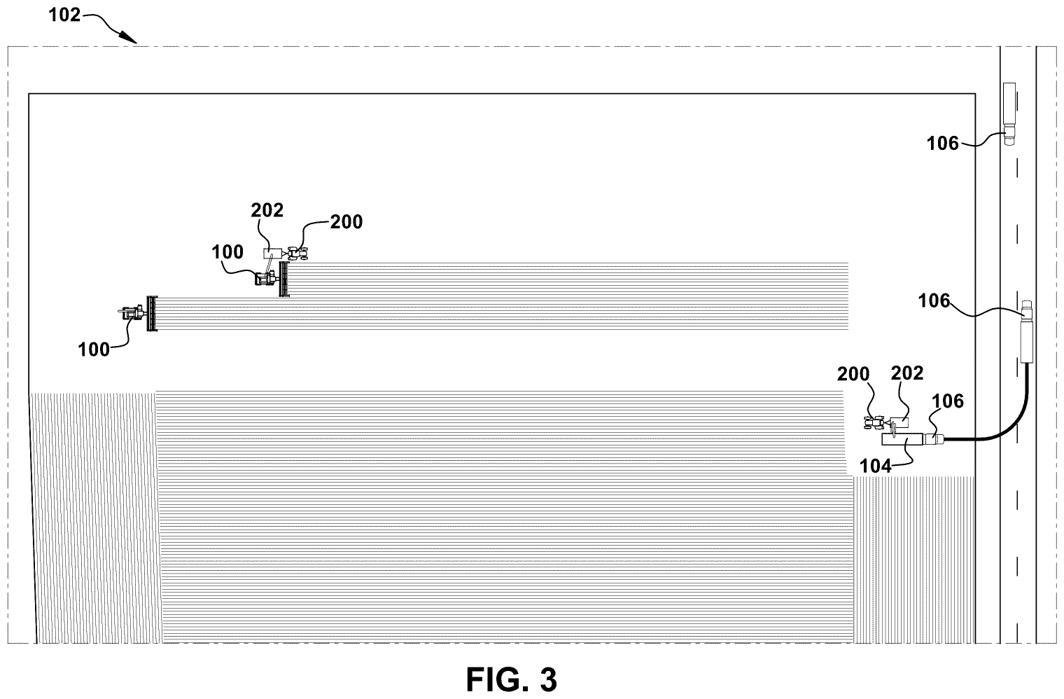

In this example, as can be seen in FIG. 1, and with reference also to FIGS. 2 and 3, multiple harvester vehicles 100 are operating in coordination (e.g., at or approximately around the same time) within a harvest system 102 to harvest and haul away (e.g., out of field) or offload harvested crop 104 using transport trucks 106 (e.g., semi-trailer truck with a bottom hopper trailer, a tractor and wagon, or truck movable detached containers), or other techniques for moving crop out of the field. It should be appreciated that one or more herein described examples maximize the overall productivity of the harvest system 102 that takes into consideration operations occurring within a field 108 (e.g., movement of harvester vehicles), as well as operations occurring outside the field 108 (e.g., movement of transport trucks 106 on a road outside of the field 108 (e.g., a commercial roadway) or delivery of harvested crop to grain silos or elevators at a different location). In some examples, multiple vehicles operate in a network environment in accordance with an illustrative example that allows communication to a controller 110 (e.g., a control system or server remote from the field 108) using a network 112 (e.g., a network or wireless communication system).

In some examples, the system can comprise a controller 110, which may comprise a single computer or a distributed computing cloud. The controller 110 comprises at least one processor for processing data and instructions, and memory for storing the instructions and data. The controller 110 can be configured to support physical databases and/or connections/communications to other external databases that store data as described herein used to coordinate movement of the vehicles in and relative to the field 108. For example, current or historical data can provide knowledge bases to different vehicles, with the databases providing online access to information from the knowledge bases. It should be noted that the harvester vehicles 100 may be any type of harvesting, threshing, crop cleaning, or other agricultural vehicle. In the illustrative example, the harvester vehicles 100 operate on the field 108, which may be any type of land used to cultivate crops for agricultural purposes, which in the illustrated example includes a headland 114 and a work area 116. As an example, the headland 114 may normally have a lower yield of crops than the work area 116, and also be an area used to make turns for harvesting passes. However, as will be described in more detail herein, the work area 116 also includes sections having higher or lower yield/productivity portions (e.g., based on predictive yield maps or a performance index).

In operation, in some examples, the harvester vehicles 100 move in the field 108 using a number of different modes of operation to aid an operator in performing agricultural tasks on the field 108. While FIG. 1 illustrates the harvester vehicles 100 traveling in a direction 117, the harvester vehicles 100 can travel in different directions and along different paths. Also, in some examples, the harvester vehicles 100 may operate relative to each other in the different modes, such as at least one of a side following mode, a teach and playback mode, a teleoperation mode, a path mapping mode, a straight mode, destination point acquisition mode, track and follow mode, a path tracking mode, and other suitable modes of operation. For example, in the path mapping mode, different paths may be mapped by one or more path planning processes as described in more detail herein to increase or maximize productivity of the harvest system 102, and in the path tracking mode, one of the harvester vehicles 100 may be the leader vehicle and the other harvester vehicles 100 may be the follower vehicles. In different illustrative examples, the different types of modes of operation may be used in combination to achieve different desired or required results. In these examples, at least one of these modes of operation may be used to control vehicle movement in a harvesting process. In some examples, each of the different types of vehicles depicted may utilize each of the different types of modes of operation to achieve the desired or required results.

Further, the path planning in some examples includes vehicle routes having multiple line segments. In other examples, the routes can have a defined pattern (e.g., a square or rectangular pattern) or follow or be bounded by field contours or boundaries. As should be appreciated, other types of patterns and bounding conditions may be used depending upon the particular implementation. Routes and patterns may be performed with the aid of a knowledge base (e.g., productivity performance index value and truck/grain cart availability) with combine path planning to increase overall harvesting productivity. In various examples, an operator may drive the harvester vehicles 100 onto the field 108 or to a beginning position of a path or route. The operator also may monitor the harvester vehicles 100 for safe operation and ultimately provide overriding control for the operation of the harvester vehicles 100.

In various examples, a path may be a preset or predefined path, the path may alternately be continuously planned with changes made by the predictive system (e.g., using the controller 110, such as based on updated harvesting conditions), and a path may be one that is directed in part by an operator using a remote control in a teleoperation mode, or some other path. The path may be any length depending on the particular implementation. The paths may be stored and accessed as desired or needed as described in more detail herein.

Thus, different illustrative examples provide a number of different modes to operate a number of different vehicles, such as the harvester vehicles 100 and using different path planning techniques and operations as described herein. Although FIG. 1 illustrates a vehicle for agricultural work, this illustration is not meant to limit the manner in which different modes and/or path panning may be applied.

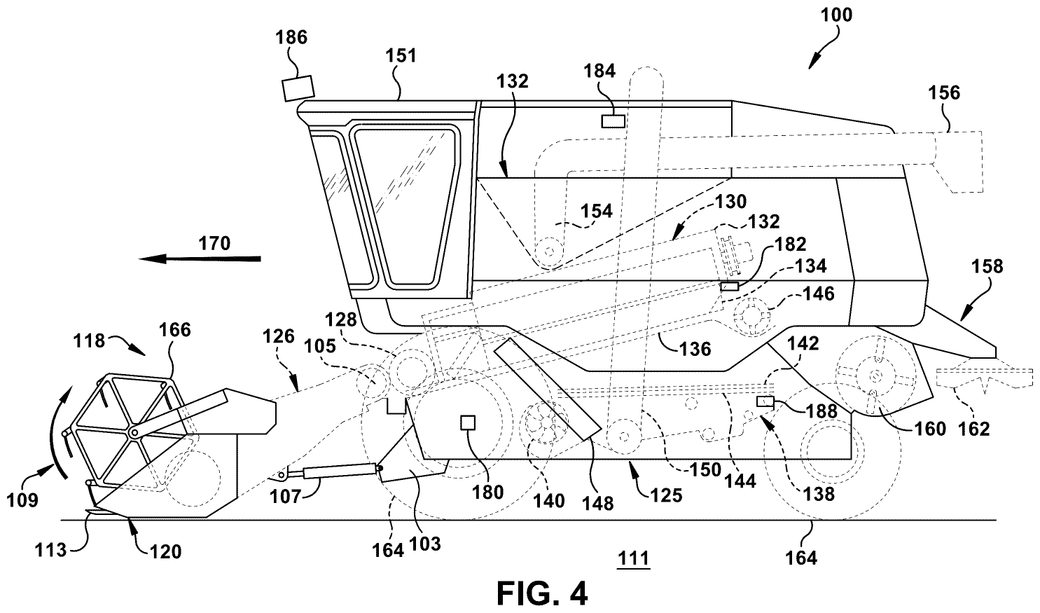

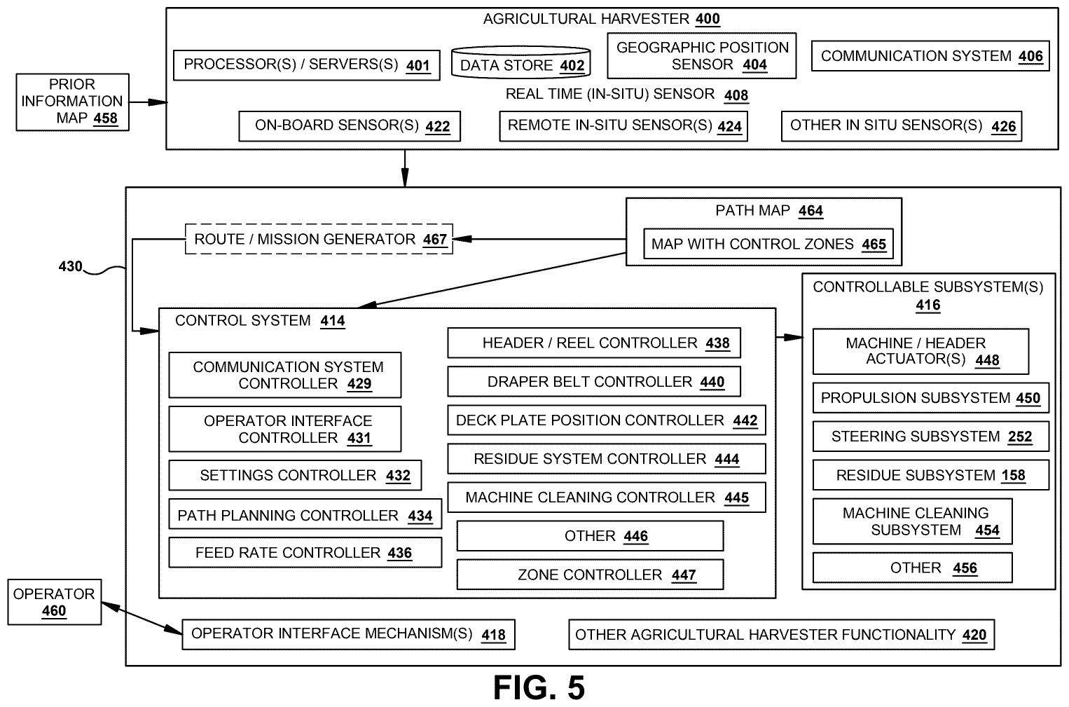

FIGS. 4 and 5 illustrate an example of the harvester vehicle 100 (and agricultural harvester 400) that may be used in one or more implementations. In various examples, movement of one or more harvester vehicles 100 (and/or the agricultural harvester 400) is planned or controlled using a productivity performance index value and transport availability. The productivity performance index is a function of at least one of in-situ data collected during an agricultural operation, predictive data generated before or during an agricultural operation, and historical data, to generate a predictive harvesting path for the harvester and, more particularly, a harvesting path using predictive characteristics, in combination with transport availability. In some examples, the predictive harvesting path can be used to control an agricultural work machine, such as an agricultural harvester (e.g., the harvester vehicle 100).

As an example, performance of an agricultural harvester may be degraded when the agricultural harvester engages a topographic feature, such as a slope, which may affect the throughput of the harvester vehicle 100 . . . . For example, the topography can cause the machine to pitch and/or roll, which can affect the stability of the machine, internal material distribution, grain loss of the machine, grain quality of the machine r, among others. For example, grain loss can be affected by a topographic characteristic that causes the harvester vehicle 100 to either pitch or roll. The increased pitch can cause grain to move out the back more quickly, decreased pitch can keep the grain in the machine, and the roll elements can overload the sides of the cleaning system and drive up more grain loss on those sides. Similarly, grain quality can be impacted by both pitch and roll, and similar to grain loss, the reactions of the material other than grain staying in the machine or leaving the machine based on the pitch or roll can be influential on the quality output. In another example, a topographic characteristic influencing pitch will have an impact on the amount of tailings entering the tailings system, thus impacting a tailings sensor output. The consideration of the pitch and the time at that level can have a relationship to how much tailings volume increases and can be useful to estimate in the need to have controls for anticipating that level and making adjustments. As should be appreciated, many different characteristics and factors can affect the harvesting operation, such as the harvesting yield/productivity.

In some examples, the controller 110 uses a predictive harvesting path, as well as real-time data acquired by in-situ sensor(s) and other devices to detect a value indicative of one or more operating or harvesting characteristics during a harvesting operation. In some examples a model can be generated that models a relationship between the characteristics of the output values from the in-situ sensors. The model is used to control operation of the harvester vehicles 100 at different locations in the field 108.

In some implementations, the predictive harvesting path can be used in automatically controlling operations during the harvesting operation. In some examples, the predictive harvesting path is used to generate a mission or path planning for the harvester vehicles 100 operating in the field 108, for example, to improve harvesting productivity (e.g., amount (mass or volume) of crop harvested per time, an area harvested per time) during harvesting operations. FIG. 4 is a partial pictorial, partial schematic, illustration of the harvester vehicle 100. In the illustrated example, the harvester vehicle 100 is a combine harvester. Further, although combine harvesters are provided as examples throughout the present disclosure, it will be appreciated that the present description is also applicable to other types of harvesters, such as cotton harvesters, sugarcane harvesters, self-propelled forage harvesters, windrowers, or other agricultural work machines. As such, the present disclosure is intended to encompass the various types of harvesters described and is, thus, not limited to combine harvesters. Moreover, the present disclosure is directed to other types of work machines, such as construction equipment, forestry equipment, and turf management equipment where generation of a predictive productivity map may be applicable. As such, the present disclosure is intended to encompass these various types of harvesters and other work machines and is, thus, not limited to combine harvesters.

As shown in FIG. 4, the harvester vehicle 100 illustratively includes an operator compartment 151, which can have a variety of different operator interface mechanisms for controlling the harvester vehicle 100. The harvester vehicle includes front-end equipment, such as a header 118, and a cutter generally indicated at 120. The harvester vehicle 100 also includes a feeder house 126, a feed accelerator 128, and a thresher generally indicated at 130. The feeder house 126 and the feed accelerator 128 form part of a material handling subsystem 125. The header 118 is pivotally coupled to a frame 103 of the harvester vehicle along pivot axis 105. One or more actuators 107 drive movement of the header 118 about the axis 105 in the direction generally indicated by the arrow 109. Thus, a vertical position of the header 118 (the header height) above a ground 111 over which the header 118 travels is controllable by actuating actuator 107. While not shown in FIG. 4, the harvester vehicle 100 may also include one or more actuators that operate to apply a tilt angle, a roll angle, or both to the header 118 or portions of header 118. Tilt refers to an angle at which the cutter 120 engages the crop. The tilt angle is increased, for example, by controlling header 118 to point a distal edge 113 of cutter 120 more toward the ground. The tilt angle is decreased by controlling header 118 to point the distal edge 113 of cutter 120 more away from the ground. The roll angle refers to the orientation of header 118 about the front-to-back longitudinal axis of the harvester vehicle 100.

The thresher 130 illustratively includes a threshing rotor 132 and a set of concaves 134. Further, the harvester vehicle also includes a separator 136. The harvester vehicle 100 also includes a cleaning subsystem or cleaning shoe (collectively referred to as cleaning subsystem 138) that includes a cleaning fan 140, a chaffer 142, and a sieve 144. The material handling subsystem 125 also includes discharge beater 146, a tailings elevator 148, a clean grain elevator 150, as well as unloading auger 154 and spout 156. The clean grain elevator moves clean grain into a clean grain tank. The harvester vehicle 100 also includes a residue subsystem 158 that can include a chopper 160 and spreader 162. The harvester vehicle 100 also includes a propulsion subsystem that includes an engine that drives ground engaging components 164, such as wheels or tracks. In some examples, the harvester vehicle 100 within the scope of the present disclosure may have more than one of any of the subsystems mentioned above. In some examples, the harvester vehicle 100 may have left and right cleaning subsystems, separators, etc., which are not shown in FIG. 4.

In operation, the harvester vehicle 100 illustratively moves through the field 108 in the direction indicated by arrow 170. As the harvester vehicle moves, the header 118 (and the associated reel 166) engages the crop to be harvested and gathers the crop toward cutter 120. An operator of the harvester vehicle can be a local human operator, a remote human operator, or an automated system. The operator of the harvester vehicle may determine one or more of a height setting, a tilt angle setting, or a roll angle setting for header 118. For example, the operator inputs a setting or settings to a control system, described in more detail below, that controls the actuator 107. The control system may also receive a setting from the operator for establishing the tilt angle and roll angle of the header 118 and implement the inputted settings by controlling associated actuators, not shown, that operate to change the tilt angle and roll angle of the header 118. The actuator 107 maintains the header 118 at a height above the ground 111 based on a height setting and, where applicable, at desired tilt and roll angles. Each of the height, roll, and tilt settings may be implemented independently of the others. The control system responds to header error (e.g., the difference between the height setting and measured height of header 118 above the ground 111 and, in some examples, tilt angle and roll angle errors) with a responsiveness that is determined based on a sensitivity level. If the sensitivity level is set at a greater level of sensitivity, the control system responds to smaller header position errors, and attempts to reduce the detected errors more quickly than when the sensitivity is at a lower level of sensitivity.

Returning to the description of the operation of the harvester vehicle, after crops are cut by cutter 120, the severed crop material is moved through a conveyor in feeder house 126 toward feed accelerator 128, which accelerates the crop material into thresher 130. The crop material is threshed by the threshing rotor 132 rotating the crop against concaves 134. The threshed crop material is moved by a separator rotor in the separator 136 where a portion of the residue is moved by the discharge beater 146 toward the residue subsystem 158. The portion of residue transferred to the residue subsystem 158 is chopped by the chopper 160 and spread on the field by the spreader 162. In other configurations, the residue is released from the harvester vehicle 100 in a windrow. In other examples, the residue subsystem 158 can include weed seed eliminators (not shown) such as seed baggers or other seed collectors, or seed crushers or other seed destroyers.

Grain falls to the cleaning subsystem 138. The chaffer 142 separates some larger pieces of material from the grain, and the sieve 144 separates some of finer pieces of material from the clean grain. The clean grain falls to an auger that moves the grain to an inlet end of clean grain elevator 150, and the clean grain elevator 150 moves the clean grain upwards, depositing the clean grain in clean grain tank. Residue is removed from the cleaning subsystem 138 by airflow generated by the cleaning fan 140. The cleaning fan 140 directs air along an airflow path upwardly through the sieves and chaffers. The airflow carries residue rearwardly in the harvester vehicle 100 toward the residue handling subsystem.

The tailings elevator 148 returns tailings to the thresher 130 where the tailings are re-threshed. Alternatively, the tailings also may be passed to a separate re-threshing mechanism by a tailing's elevator or another transport device where the tailings are re-threshed as well.

FIG. 4 also shows that, in one example, the harvester vehicle 100 includes a ground speed sensor 180, one or more separator loss sensors 182 (also referred to as the loss sensor 182), a clean grain camera 184, a forward looking image capture mechanism 186, which may be in the form of a stereo or mono camera, and one or more cleaning subsystem loss sensors 188 provided in the cleaning subsystem 138.

The ground speed sensor 180 senses the travel speed of the harvester vehicle over the ground. The ground speed sensor 180 may sense the travel speed of the harvester vehicle 100 by sensing the speed of rotation of the ground engaging components (such as wheels or tracks), a drive shaft, an axle, or other components. In some examples, the travel speed may be sensed using a positioning system, such as a global positioning system (GPS), a dead reckoning system, a long range navigation (LORAN) system, a Doppler speed sensor, or a wide variety of other systems or sensors that provide an indication of travel speed. The ground speed sensors 180 can also include direction sensors such as a compass, a magnetometer, a gravimetric sensor, a gyroscope, GPS derivation, to determine the direction of travel in two or three dimensions in combination with the speed. This way, when the harvester vehicle is on a slope, the orientation of the harvester vehicle 100 relative to the slope is known. For example, an orientation of the harvester vehicle 100 can include ascending, descending or transversely travelling the slope. Machine or ground speed, when referred to in this disclosure can also include the two or three dimension direction of travel.

The loss sensors 188 illustratively provide an output signal indicative of the quantity of grain loss occurring in both the right and left sides of the cleaning subsystem 138. In some examples, the loss sensors 188 are strike sensors which count grain strikes per unit of time or per unit of distance traveled to provide an indication of the grain loss occurring at the cleaning subsystem 138. The loss sensors 188 for the right and left sides of the cleaning subsystem 138 may provide individual signals or a combined or aggregated signal. In some examples, the loss sensors 188 may include a single sensor as opposed to separate sensors provided for each cleaning subsystem 138.

The loss sensors 182 provide a signal indicative of grain loss in the left and right separators, not separately shown in FIG. 4. The loss sensors 182 may be associated with the left and right separators and may provide separate grain loss signals or a combined or aggregate signal. In some instances, sensing grain loss in the separators may also be performed using a wide variety of different types of sensors as well.

The harvester vehicle 100 may also include other sensors and measurement mechanisms. For example, the harvester vehicle 100 may include one or more of the following sensors: a header height sensor that senses a height of the header 118 above the ground 111; stability sensors that sense oscillation or bouncing motion (and amplitude) of the harvester vehicle 100; a residue setting sensor that is configured to sense whether the harvester vehicle is configured to chop the residue, produce a windrow, etc.; a cleaning shoe fan speed sensor to sense the speed of the fan 140; a concave clearance sensor that senses clearance between the rotor 132 and concaves 134; a threshing rotor speed sensor that senses a rotor speed of rotor 132; a chaffer clearance sensor that senses the size of openings in chaffer 142; a sieve clearance sensor that senses the size of openings in sieve 144; a material other than grain (MOG) moisture sensor that senses a moisture level of the MOG passing through the harvester vehicle 100; one or more machine setting sensors configured to sense various configurable settings of the harvester vehicle 100; a machine orientation sensor that senses the orientation of the harvester vehicle 100; and crop property sensors that sense a variety of different types of crop properties, such as crop type, crop moisture, and other crop properties. Crop property sensors may also be configured to sense characteristics of the severed crop material as the crop material is being processed by the harvester vehicle 100. For example, in some instances, the crop property sensors may sense grain quality such as broken grain, MOG levels; grain constituents such as starches and protein; and grain feed rate as the grain travels through the feeder house 126, clean grain elevator 150, or elsewhere in the harvester vehicle 100. The crop property sensors may also sense the feed rate of biomass through feeder house 126, through the separator 136 or elsewhere in the harvester vehicle 100. The crop property sensors may also sense the feed rate as a mass flow rate of grain through the clean grain elevator 150 or through other portions of the harvester vehicle 100 or provide other output signals indicative of other sensed variables.

Examples of sensors used to detect or sense the power characteristics include, but are not limited to, a voltage sensor, a current sensor, a torque sensor, a hydraulic pressure sensor, a hydraulic flow sensor, a force sensor, a bearing load sensor, and a rotational sensor. Power characteristics can be measured at varying levels of granularity. For example, power usage can be sensed machine-wide, subsystem-wide or by individual components of the subsystems.

Examples of sensors used to detect internal material distribution include, but are not limited to, one or more cameras, capacitive sensors, electromagnetic or ultrasonic time-of-flight reflective sensors, signal attenuation sensors, weight or mass sensors, material flow sensors, etc. These sensors can be placed at one or more locations in the harvester vehicle 100 to sense the distribution of the material in the harvester vehicle 100, during the operation of the harvester vehicle 100.

Examples of sensors used to detect or sense a pitch or roll of the harvester vehicle 100 include accelerometers, gyroscopes, inertial measurement units, gravimetric sensors, magnetometers, etc. These sensors can also be indicative of the slope of the terrain that the harvester vehicle 100 is currently on.

Prior to describing how the harvester vehicle is controlled using the harvesting path plan, a brief description of some of the items on the harvester vehicle, and corresponding operation, will first be described. The harvester vehicle 100 receives a general type of the harvesting path plan in some examples and combines the plan with a georeferenced sensor signal generated by an in-situ sensor, where the sensor signal is indicative of a characteristic in the field 108, such as characteristics of crop or weeds present in the field 108. Characteristics of the field 108 may include, but are not limited to, field characteristics such as slope, weed intensity, weed type, soil moisture, geology such as soil type, surface quality; characteristics of crop properties such as crop height, crop moisture, crop density, crop state, crop yield; characteristics of grain properties such as grain moisture, grain size, grain test weight; and characteristics of machine performance such as loss levels, job quality, fuel consumption, feedrate, throughput, and power utilization. A relationship between the characteristic values obtained from in-situ sensor signals and the combine path plan is identified, and that relationship is used to generate updates or dynamic changes as needed to maintain harvest performance or harvest productivity.

It should be noted that the predictive harvesting path, based on the productivity performance index (e.g., value), can use predicted yield values at different geographic locations in the field 108, and one or more of those values makes up a part of the productivity performance index for controlling the harvester vehicle 100. In some examples, the predictive harvesting path can be presented to a user, such as an operator of an agricultural work machine (e.g., a harvester vehicle 100, a tractor and grain cart, a truck) or a remote manager of the harvest operation, such as using a user display/interface (e.g., display, touch screen, other data display types and input types). The harvesting path plan can be presented to a user visually (e.g., a route map), such as via a display, haptically, or audibly. The user can interact with the predictive harvesting path to perform editing operations, for example, and other user interface operations. In some examples, the predictive harvesting path can be used for controlling an agricultural work machine, such as an agricultural harvester, for presentation to an operator or other user, and for presentation to an operator or user for interaction by the operator or user.

In another example, the productivity performance index (e.g., value) can be presented to a user, such as an operator of an agricultural machine (e.g., a harvest vehicle 100, a tractor and grain cart, a truck) or a remote manager of the harvest operation. The productivity performance index can be presented to the user visually (e.g., a map), such as via a display. In another example, the impact of the productivity performance index on the field productivity or field operation can be presented to a user (e.g., agricultural machine operator, remote manager). Impact of productivity performance index on the field productivity or field operation can be provided in the form of a target rate (e.g., speed, feedrate, throughput, area per time) of harvest or a maximum rate (e.g., speed, feedrate, throughput, area per time) of harvest. In an additional example, as an impact of productivity performance index on the field productivity or field operation, an indication of time to complete the work based on the plan or an indication of time(s) when an agricultural machine will arrive at or be in position at specific locations can also be presented to a user (e.g., agricultural machine operator, remote manager). In some examples, the presentation to the user (e.g., agricultural machine operator, remote manager) can include explanations, such as explanations (e.g., reasons) for the value of the productivity index (e.g., influencing factors or attributes that affect productivity index) or the selection of a path based on the productivity index. The information presented in the form of a map can be done by individual locations, zones, or field level communications. The presentation of information to a user (e.g., agricultural machine operator, remote manager) can also be in the form of symbols, colors, text, icons, audible tones, or other indicators used to communicate information.

FIG. 5 is a schematic block diagram showing some portions of an example agricultural harvester 400, which may be embodied as the harvester vehicle 100. FIG. 5 shows that agricultural harvester 400 illustratively includes one or more processors or servers 401, a data store 402, a geographic position sensor 404, a communication system 406, and one or more in-situ sensors 408 that sense one or more agricultural characteristics of a field concurrent with a harvesting operation. An agricultural characteristic can include any characteristic that can have an effect on the harvesting operation. Some examples of agricultural characteristics include characteristics of the harvesting machine, the field, the plants or crop on the field, and the weather. Other types of agricultural characteristics are also included. The in-situ sensors 408 generate values corresponding to the sensed characteristics. As an example, this collected and historical data is used to generate a productivity performance index value, that provides a metric representing a level of harvesting productivity (e.g., amount of crop per time, an amount of area per time). The productivity performance index value can be representative of an area of the field, a potential harvesting path or pass in the field, and may be adjusted based on in-situ data, such as crop conditions, environmental conditions, soil conditions, condition of the harvester, and more.

A system for improving the productivity of the agricultural harvester 400 can also comprise a mapping subsystem 430 (e.g., with a path controller) that generates a field map to guide the harvester 400 based on the predictive harvesting path. The mapping subsystem 430 uses a predictive path map 464 to control movement of the agricultural harvester 400 using a control system 414, one or more harvester control subsystems 416, and an operator interface mechanism 418. The operator interface 418 can comprise a user display that displays the generated field map (e.g., with a predictive path) to the operator. In this example, the harvester control subsystem can comprise the harvester propulsion (e.g., propulsion subsystem 450) and/or a harvester steering control (e.g., steering subsystem 452) to control movement and speed of the harvester 400.

The agricultural harvester 400 can also include a wide variety of other agricultural harvester functionality 420. The in-situ sensors 408 include, for example, on-board sensors 422, remote sensors 424, and other sensors 426 that sense characteristics of a field or machine during the course of an agricultural operation. The control system 414 includes communication system controller 429, operator interface controller 431, a settings controller 432, path planning controller 434, feed rate controller 436, header and reel controller 438, draper belt controller 440, deck plate position controller 442, residue system controller 444, machine cleaning controller 445, zone controller 447, and can include other items 446. The controllable subsystems 416 include machine and header actuators 448, propulsion subsystem 450, steering subsystem 452, residue subsystem 458, machine cleaning subsystem 454, and subsystems 416 can include a wide variety of other subsystems 456.

As can be seen, the agricultural harvester 400 can receive an existing information map 458 (e.g., historical map). As described below, the existing information map 458 includes, for example, a topographic map from a prior operation in the field 108, such as an unmanned aerial vehicle completing a range scanning operation from a known altitude, a topographic map sensed by a plane, a topographic map sensed by a satellite, a topographic map sensed by a ground vehicle, such as a GPS-equipped planter, etc. For example, a topographic map can be retrieved from a remote source such as the United States Geological Survey (USGS). However, the existing information map 458 may also encompass other types of data that were obtained prior to a harvesting operation or a map from a prior operation. Additionally, for example, existing information map 458 could be a vegetative index map (e.g., NDVI), a moisture map, a crop health map, a historical yield map, or other types of maps that map characteristics of the field.

FIG. 5 further illustrates that an operator 460 may operate the agricultural harvester 400. The operator 460 interacts with the operator interface mechanisms 418. In some examples, the operator interface mechanisms 418 may include joysticks, levers, a steering wheel, linkages, pedals, buttons, dials, keypads, user actuatable elements (such as icons, buttons, etc.) on a user interface display device, a microphone and speaker (where speech recognition and speech synthesis are provided), among a wide variety of other types of control devices. Where a touch sensitive display system is provided, the operator 460 may interact with the operator interface mechanisms 418 using touch gestures. These examples described above are provided as illustrative examples and are not intended to limit the scope of the present disclosure. As such, other types of operator interface mechanisms 418 may be used and are within the scope of the present disclosure.

The existing information map 458 may be downloaded onto agricultural harvester 400 and stored in data store 402, using the communication system 406 or in other ways. In some examples, the communication system 406 may be a cellular communication system, a system for communicating over a wide area network or a local area network, a system for communicating over a near field communication network, or a communication system configured to communicate over any of a variety of other networks or combinations of networks. The communication system 406 may also include a system that facilitates downloads or transfers of information to and from a secure digital (SD) card or a universal serial bus (USB) card or both.

The geographic position sensor 404 illustratively senses or detects the geographic position or location of agricultural harvester 400. The geographic position sensor 404 can include, but is not limited to, a global navigation satellite system (GNSS) receiver that receives signals from a GNSS satellite transmitter. The geographic position sensor 404 can also include a real-time kinematic (RTK) component that is configured to enhance the precision of position data derived from the GNSS signal. The geographic position sensor 404 can include a dead reckoning system, a cellular triangulation system, or any of a variety of other geographic position sensors.

The in-situ sensors 408 may be any of the sensors described above with respect to FIG. 4. The in-situ sensors 408 include on-board sensors 422 that are mounted on-board the agricultural harvester 400. Such sensors may include, for instance, a speed sensor (e.g., a GPS, speedometer, or compass), image sensors that are internal to the agricultural harvester 400 (such as the clean grain camera or cameras mounted to identify material distribution in harvester vehicle 100, for example, in the residue subsystem or the cleaning system), image sensors that are external to the agricultural harvester 400 (such as forward looking image capture mechanism 186 or rearward looking cameras to identify characteristics of the field), grain loss sensors, tailings characteristic sensors, and grain quality sensors, among other sensors. The in-situ sensors 408 also include remote in-situ sensors 424 that capture in-situ information. In-situ data includes data taken from a sensor on-board the harvester or taken by any sensor where the data are detected during the harvesting operation.

In various examples, the predictive path map 464 (e.g., predictive productivity map) is used to generate one or more routes for the agricultural harvester 400 using the productivity performance index, which can be based on the existing information map 458, sensed information received from one or more sensors, predicted information, and/or other information relating to the harvesting operation being performed in the field 108, as described in more detail herein. For example, using predicted throughput information and out of field transport availability information, as well as other operational or harvesting conditions or characteristics received from one or more sensors, the predictive path map 464 is generated to coordinate movement of the agricultural harvester 400, such as with other agricultural harvesters 400, as well as other vehicles within and outside of the field 108. It should be noted that the predictive path map 464 in some examples is based on different models or predictive methods that uses relationships between prior information, existing information, in-situ information, and other data. For example, the predictive path map 464 can be based on a predictive model generated by a predictive model generator to generate a functional predictive characteristic map that predicts the characteristic of the harvest operation based on machine, crop, grain or field characteristics (e.g., which can vary at different locations of the field 108, such as in different field zones), and the availability of off-site transport for use in harvesting operations.

As described herein, the predictive path map 464 (e.g., predictive productivity map) is generated using a productivity performance index (e.g., value), and out of field transport availability. The productivity performance index can be based on field conditions, such as topographic characteristics, soil conditions, crop conditions, and other information identified by the existing information map 458, and predicted characteristics at different locations in the field 108. The productivity performance index value can also be generated, in some examples, using predicted values of a sensed characteristic (e.g., sensed by in-situ sensors 408), or a characteristic related to the sensed characteristic, at various locations across the field 108 based upon a prior information value in existing information map 458 at those locations and using the predictive model. For example, if the predictive model indicates a relationship between a topographic characteristic and crop yield, then, given the topographic characteristics at different locations across the field 108, harvesting path routes along different locations across the field 108 can be adjusted as described in more detail herein. One or more characteristics at those locations and the relationship between the characteristics and machine operation, obtained from the predictive model, are used to generate the productivity performance index in some examples. It should be noted that there are variations in the data types that are mapped in the existing information map 458, the data types sensed by in-situ sensors 408, and the data types in the productivity performance index, in some examples.

In some examples, the existing information map 458 is from a prior operation through the field 108 and the data type is the same as the data type sensed by in-situ sensors 408, and the data type in the predictive path map 464 (e.g., predictive productivity map) is also the same as the data type sensed by the in-situ sensors 408. For example, the existing information map 458 may be a yield map generated during a previous year, and the variable sensed by the in-situ sensors 408 may be yield (e.g., amount per area or time). The routes for the predictive path map 464 may then be generated using the productivity performance index, which is based in part on a predictive yield map that maps predicted yield values to different geographic locations in the field 108. In such an example, the relative yield differences in the georeferenced existing information map 458 from the prior year can be used to generate a predictive model that models a relationship between the relative yield differences on the existing information map 458 and the yield values sensed by in-situ sensors 408 during the current harvesting operation.

In some examples, the predictive path map 464 can be provided as one or more sub-maps having routes with control or field zones, illustrated as a map with control zones 465. For example, contiguous individual point data values on a predictive map are grouped into control zones. A control zone 465 may include two or more contiguous portions of an area, such as the field 108, for which a control parameter corresponding to the control zone for controlling a controllable subsystem is constant. For example, a response time to alter a setting of controllable subsystems 416 may be inadequate to satisfactorily respond to changes in values contained in a map. In that case, control zones are identified that are of a defined size to accommodate the response time of the controllable subsystems 416. In another example, control zones may be sized to reduce wear from excessive actuator movement resulting from continuous adjustment. In some examples, there may be a different set of control zones for each controllable subsystem 416 or for groups of controllable subsystems 416. The control zones may be added to the predictive path map 464 to obtain a map with control zones 465 (also referred to as a control zone map 465). The control zone map 465 can thus be similar to predictive path map 464 except that the control zone map 465 includes control zone information defining the control zones. Thus, the predictive path map 464 may or may not include control zones.

Similarly, productivity index values may be aggregated into field zones based on the values proximity and similarity to one another. For example, it may be that a small portion of a field is determined to have a high productivity index value, but a much larger surrounding or proximate portion of the field is determined to have a low productivity index value. In such case, the high productivity index value portion may be aggregated into a field zone with the low productivity index value portion because the high productivity index value portion is not accessible without first harvesting the low productivity index value portion. In this example, the high productivity index value portion and low productivity index value portion would be aggregated into one larger field zone with low productivity value. In another example, a low productivity index value portion may be aggregated into a high productivity index value portion. Other considerations for aggregation of productivity index values are also contemplated, and the example herein is not to be considered limiting.

In some examples, multiple crops may be simultaneously present in the field 108 if an intercrop production system is implemented. In that case, the examples described herein are able to identify the location and characteristics of the two or more crops and generate the predictive path map 464 and the control zone map 465 accordingly. It should also be appreciated that values can be clustered to generate control zones and the control zones can be added to the control zone map 465, or a separate map, showing only the control zones that are generated. In some examples, the control zones may only be used for controlling or calibrating agricultural harvester 400 or both. In other examples, the control zones may be presented to the operator 460 and used to control or calibrate agricultural harvester 400 and in other examples the control zones may just be presented to the operator 460 or another user or stored for later use.

The predictive path map 464 (and/or the control zone map 465) may be provided to the control system 414, which generates control signals based upon the predictive path map 464 (and/or the control zone map 465). In some examples, the communication system controller 429 controls communication system 406 to communicate the predictive path map 464 (and/or the control zone map 465) or control signals based on the predictive path map 464 (and/or the control zone map 465) to other agricultural harvesters (or vehicles) that are harvesting in the same field 108. In some examples, the communication system controller 429 controls the communication system 406 to send the predictive path map 464 (and/or the control zone map 465) to other remote systems.

In some examples, predictive path map 464 (and/or the control zone map 465) can be provided to route/mission generator 467. The route/mission generator 467 plots a travel path for the agricultural harvester 400 to travel on during the harvesting operation based on the predictive path map 464 (and/or the control zone map 465). The travel path can also include machine control settings corresponding to locations along the travel path as well. For example, if a travel path ascends a hill, then at a point prior to hill ascension, the travel path can include a control indicative of directing power to propulsion systems to maintain a speed or feed rate of the agricultural harvester 400. In some examples, the route/mission generator 467 analyzes the different orientations of the agricultural harvester 400 and the predicted characteristics to generate routes according to predictive path map 464 (and/or the control zone map 465, collectively a predictive productivity map), for a plurality of different travel routes, and selects a route that has desirable results (such as, quick harvest time or desired average throughput).

The operator interface controller 431 is operable to generate control signals to control operator interface mechanisms 418. The operator interface controller 431 is also operable to present the predictive path map 464 (and/or the control zone map 465) or other information derived from or based on the predictive path map 464 (and/or the control zone map 465) to the operator 460. The operator 460 may be a local operator or a remote operator. As an example, the controller 431 generates control signals to control a display mechanism to display one or both of the predictive path map 464 (and/or the control zone map 465) for the operator 460. The controller 431 may generate operator actuatable mechanisms that are displayed and can be actuated by the operator to interact with the displayed map. The operator can edit the map by, for example, correcting information displayed on the map, based on the operator's observation. The settings controller 432 can generate control signals to control various settings on the agricultural harvester 400 based upon the predictive path map 464 (and/or the control zone map 465). For instance, the settings controller 432 can generate control signals to control machine and header actuators 448. In response to the generated control signals, the machine and header actuators 448 operate to control, for example, propulsion settings, steering settings, one or more of the sieve and chaffer settings, thresher clearance, rotor settings, cleaning fan speed settings, header height, header functionality, reel speed, reel position, draper functionality (where the agricultural harvester 400 is coupled to a draper header), corn header functionality, internal distribution control and other actuators 448 that affect the other functions of the agricultural harvester 400.

The path planning controller 434 illustratively generates control signals to control steering subsystem 452 to steer the agricultural harvester 400 according to a desired path. The path planning controller 434 can control a path planning system to generate a route for the agricultural harvester 400 and can control the propulsion subsystem 450 and steering subsystem 452 to steer the agricultural harvester 400 along that route. The feed rate controller 436 can control various subsystems, such as propulsion subsystem 450 and machine actuators 448, to control a feed rate based upon the predictive path map 464 (and/or the control zone map 465). For instance, as the agricultural harvester 400 approaches a declining terrain having an estimated speed value above a selected threshold, the feed rate controller 436 may reduce the speed of the agricultural machine 400 to maintain constant feed rate of biomass through the agricultural harvester 400.

The header and reel controller 438 can generate control signals to control a header or a reel or other header functionality. The draper belt controller 440 can generate control signals to control a draper belt or other draper functionality based upon the predictive path map 464 (and/or the control zone map 465). For example, as the agricultural harvester 400 approaches a declining terrain having an estimated speed value above a selected threshold, the draper belt controller 440 may increase the speed of the draper belts to prevent backup of material on the belts. The deck plate position controller 442 can generate control signals to control a position of a deck plate included on a header based on the predictive path map 464 (and/or the control zone map 465), and the residue system controller 444 can generate control signals to control a residue subsystem 158 based upon the predictive path map 464 (and/or the control zone map 465). The machine cleaning controller 445 can generate control signals to control the machine cleaning subsystem 454. For instance, as the agricultural harvester 400 is about to transversely travel on a slope where it is estimated that the internal material distribution will be disproportionally on one side of cleaning subsystem 454, the machine cleaning controller 445 can adjust cleaning subsystem 454 to account for, or correct, the disproportionate material. Other controllers included on the agricultural harvester 400 can control other subsystems based on the predictive path map 464 (and/or the control zone map 465).

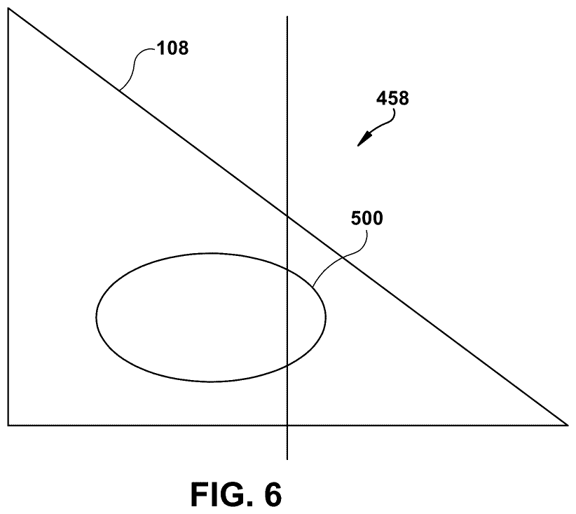

In some examples, the existing information map 458 includes information relating to different characteristics of the field 108 as shown in FIG. 6. As illustrated, the existing information map 458 includes data corresponding to the dimensions (e.g., size and shape) of the field 108 that can be used to predict travel time of the agricultural harvester 400 along different portions of the field 108, a number of turns of the agricultural harvester 400 in different portions of the field 108, etc., which can vary based on the dimensions of the field 108 and direction of travel of the harvester, as well as other characteristics of the field 108. In this way, for example, predicted paths (e.g., from the predictive productivity map) may be identified that provide for a higher level of harvesting production. For example, one long path, such as along the bottom horizontal boundary of the field 108, would have more productivity than several short paths at the top left hand corner of the field 108. That is, in order to cover the same area of a single path along the bottom horizontal boundary, a path at the top left corner would involve several turns, where each turn reduces the harvesting productivity of the harvester. As such, in this example, the productivity performance index for a path along the bottom boundary is higher than that of the path in the top left corner.

As another example, the existing information map 458 identifies a low yield area 500 of the field 108. In the low yield area 500, the yield of harvested crop is predicted to be lower than in other areas of the field 108, as such, the productivity performance index value is lower. In some examples, to improve or maximize productivity of the harvest system 102, the low yield area 500 can be harvested when the availability of out of field transport is lower or unavailable. As such, one or more examples utilizes information relating to the varying crop yield across the field 108 to control operation of the agricultural harvester 400, such as by generating a corresponding predictive path map 464, which can be adjusted or varied based on in-situ or real-time information, such as truck and cart availability (e.g., time to next available cart). That is, the productivity performance index value for a path is combined with the out of field transport availability to determine a predictive path during operations. As such, the harvest system productivity is improved in various examples by generating a travel path with routes that provide availability of trucks and carts for transporting harvested crop, while keeping the agricultural harvesters 400 working.

In some examples, using the predicted productivity and availability information, improved usage of trucks and carts is provided wherein low cost per hour machines are not operational and high cost per hour machines are operational. That is, the operation of the high cost per hour machines is maximized using one or more examples.

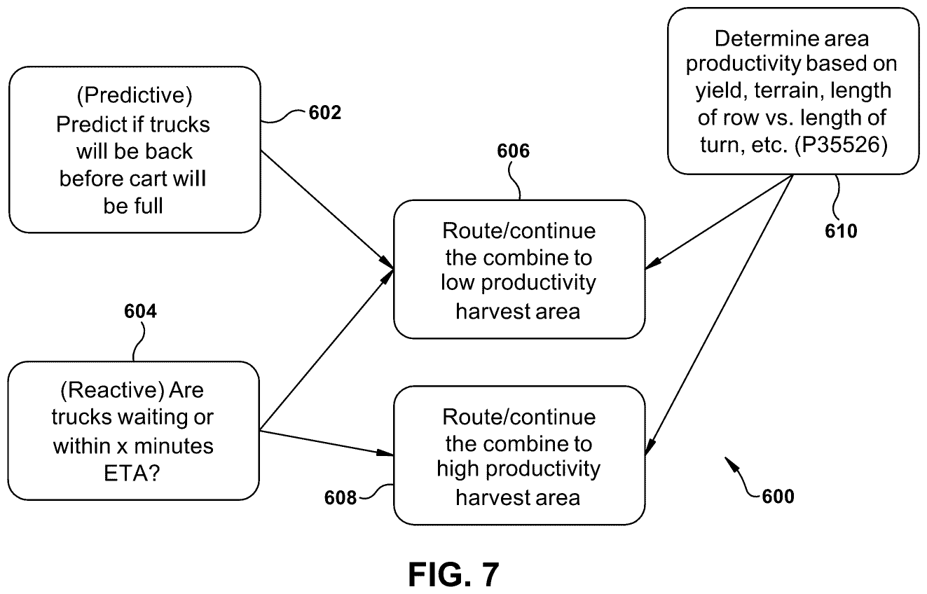

FIG. 7 illustrates a process flow 600 for path planning in accordance with various examples. The process flow 600 includes a predictive component 602 and a reactive component 604. That is, the predictive productivity map (e.g., predictive path map 464) is generated (and/or updated) using predictive information and reactive information. In one example, the predictive component 602 predicts the availability of trucks to receive harvested crop from the carts that collect the harvested crop. For example, the predictive component 602 predicts whether one or more trucks will be available for the operating agricultural harvester 400 to offload crop before the harvester or another cart is full of harvested crop. Based on the prediction, predictive productivity map can be created or updated. For example, the movement of the agricultural harvester 400 can be controlled along paths to higher or lower yield areas of the field 108 (e.g., based on the productivity performance index value), longer or shorter runs along the field 108, etc.

In one example, the reactive component 604 determines whether trucks are waiting or are within a determined time period for arrival (e.g., estimated time of arrival (ETA)). That is, based on loading and unloading times at a grain silo, grain elevator, or at a transport truck, travel times for the truck and cart to the unloading locations, travel times for the truck and cart to receiving locations, time to unload, time at a location, history of the location (such as unloading and wait times), driving time, truck movement and locations, traffic on route, etc., waiting or predicted ETAs can be determined. For example, one or more algorithms or models as described herein can be used to predict the arrival times of the trucks and carts based on current harvest operation information. It should be noted that the operating conditions or characteristics of the harvest system 102 can be updated continuously or periodically to adjust the routes of the harvester vehicles 100 using predictive and reactive information to, for example, reduce a backup or waiting time for the trucks and carts.

Based on the determinations from the predictive component 602 and the reactive component 604, one or more examples control the operation of the agricultural harvesters 400, such as the harvester vehicles 100 in the field 108. For example, at 606, one or more of the harvester vehicles 100 can be routed or continue (based on the predictive productivity map, such as a predictive path map 464) to the low productivity harvest areas, such as the low yield area 500. Alternatively or additionally, one or more of the harvester vehicles 100 in the field 108 can be routed or continue (based on the predictive path map 464) to the high productivity harvest areas, such as outside of the low yield area 500. As such, based on the predicted throughput and the availability of the truck and cart, path planning can be performed for the harvester vehicles 100 and adjusted using determinations from the predictive component 602 and the reactive component 604.

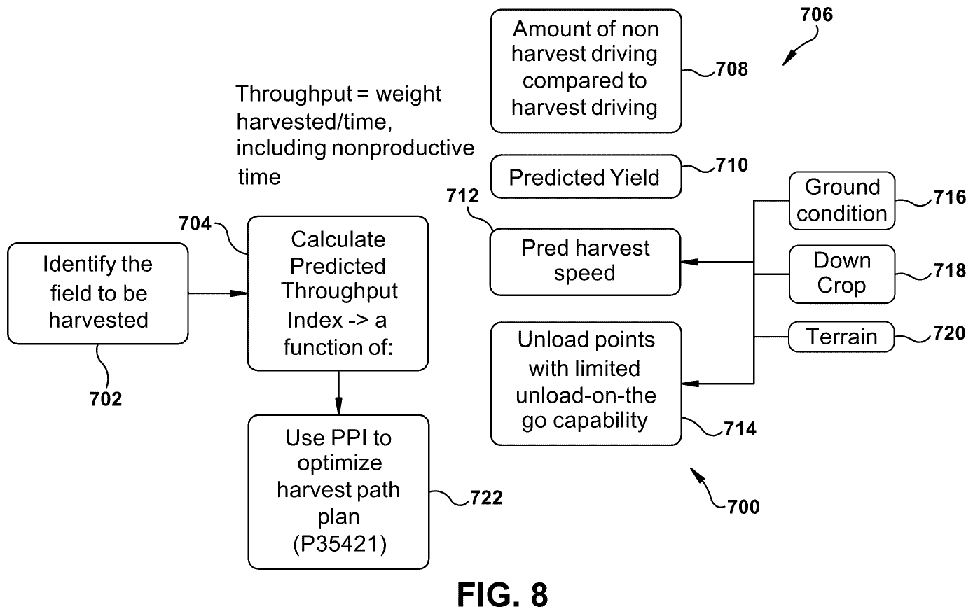

In some examples, the routing determinations at 606 and 608 are based in part a productivity performance index (e.g., value)_calculated at 610. For example, as described in more detail herein, the productivity performance index determines area productivity, such as at different areas of the field 108, based on yield, terrain, length of row versus length of turn, etc. It should be appreciated that different characteristics can be used as described herein. In some examples, the productivity performance index evaluates different conditions or characteristics of the harvesting operations as illustrated in FIG. 8. In particular, a process flow 700 is shown that includes identifying the field to be harvested at 702 (e.g., the field 108) and then calculating the productivity performance index at 704, which in this example is a predicted productivity index that is a function of a plurality of variables 706. In one examples, the variables 706 include an amount of non-harvest driving compared at harvest driving data 708, predicted yield data 710, predicated harvest speed data 712 and unload points with limited unload-on-the-go capability data 714. In some examples the data 712 and 714 is based on ground condition data 716, down crop data 718, and terrain data 720, among others.

The calculated productivity performance index (PPI) (e.g., value) is used to optimize the harvest path at 722, and to create a predictive productivity map. More particularly, and returning to the process flow 600, the PPI is used in the route determinations at 606 and 608.

It should be noted that in some examples, temporal learning is used based on changing information relating to the operating conditions of the harvest system 102 as described herein (e.g., times when grain elevators are busier, trends in the grain elevators, etc.). It should also be noted that one or more algorithms used in various examples can be performed on-board the harvester vehicles 100, off-board the harvester vehicles 100, at a plurality of the harvester vehicles 100, at different remote locations, or a combination thereof, among others. It should be noted that in various examples, the data used to calculate the PPI includes real-time, predicted or in-situ data and historical data. In some examples, machine learning is used to optimize the paths as described in more detail herein.

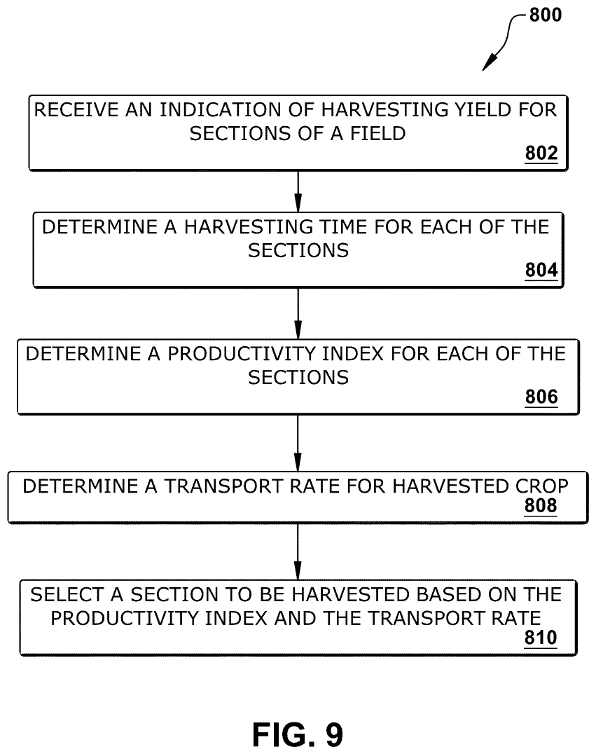

In some examples, the PPI is calculated by a harvesting efficiency improvement system for agricultural operations and implemented as the controller 110 (shown in FIG. 1). More particularly, the PPI is calculated to control operation, and in particular the routes or paths of one or more agricultural machines (e.g., the harvester vehicles 100) configured to harvest and process crop during an agricultural operation. In some examples, a plurality of carts (e.g., the carts 202) are configured to receive harvested crop from the agricultural machine, namely the harvester vehicles 100 (which may be configured as the agricultural harvester 400) and transport the harvested crop during the agricultural operation. Grain carts can be used to receive the harvested crop from the harvester, and a plurality of trucks (e.g., the transport trucks 106) can be used to receive the harvested crop from the one or more of the plurality of carts 202, to transport the harvested crop off site. In some implementations, the grain carts can be used for off-site transport, such as being towed to the storage or processing facility. In one or more examples, the controller 110 is configured to control operations within the harvest system 102, for example, determine routes or paths for the one or more agricultural machines to increase or maximize crop harvest throughput using the method 800 shown in FIG. 9.

The method 800 can be implemented by the controller 110 of the harvest system 102. However, it should be appreciated that method 800 may likewise be carried out by any of the other described implementations (e.g., performed using one or more configurations described in more detail herein). The method 800 includes receiving an indication of harvesting yield for each section of an agricultural area in which the agricultural operation is performed at 802. For example, historical yield rates for various sections of the field 108 are received. As another example, predictive yield values can be generated for various sections of the field 108. As described in more detail herein, the harvesting yield data allows for a determination of one or more low yield areas 500 of the field 108. The method 800 also determines a harvesting time for each of the sections of the field 108 at 804. For example, a determination is made as to a length of harvesting time for each section of the agricultural area based on a plurality of characteristics of the field (e.g., soil condition, down crop quantification, terrain, etc.) associated with each section of the agricultural area as described in more detail herein.

Further, in some examples, the harvesting time for each section of the agricultural area can be determined based on the field size (e.g. length of harvest pass), the shape of the field (e.g., as well as the planting direction/path), the number of turns required to complete the section of the field, and field features (e.g. waterways, terraces, obstructions such as irrigations, power lines). Other characteristics of the field may impact the harvesting time as well. Additionally, or alternatively, non-harvesting time can also be determined for each of the sections of the field 108 using characteristics of the field. For example, the non-harvesting time for each section of the agricultural area can be determined based on the field size, the shape of the field, the number of turns required to complete the field, field features (e.g. waterways, terraces, in field roadways, obstructions such as irrigations, power lines), previously harvested areas of the field, areas of the field where crop is not present (e.g. areas that have been subjected to flooding). Other characteristics of the field may impact the non-harvesting time as well.

The method 800 further determines a productivity performance index (e.g., value) for each section of the agricultural area at 806. For example, the PPI is determined for each of the sections based on the received indication of harvesting yield and the determined length of harvesting time for each section of the agricultural area as described in more detail herein. In some examples, the productivity performance index for each section of the agricultural area is further based on the amount of harvesting time relative to the amount of non-harvesting time of the agricultural machine for each section of the agricultural area and/or on an assessment of unload-on-the-go points for each section of the agricultural area.

An out of field transport rate for the harvested crop is determined at 808. For example, the out of field transport rate for the harvested crop is determined based on a quantification of availability of at least one of the plurality of carts and the plurality of trucks to receive the harvested crop as described in more detail herein. For example, the method 800 predicts truck and cart availability at one or more locations of grain transfer based on current operating times and locations of the trucks and carts, as well as historical data relating to unloading crop, wait times, etc. That is, the out of field transport rate identifies the rate at which harvested crop can be transported from the harvester vehicles.

The method 800 then selects a section of the agricultural area to be harvested at 810. For example, the section of the agricultural area to be harvested is selected based on either, or both, the determined out of field transport rate of the harvested crop and the determined productivity performance index for each section of the agricultural area. In some examples, the selection of one or more sections defines a harvesting path defining routes for harvesting by one or more harvester vehicles. It should be noted that different factors can be used to select the one or more sections, such as based on the distance between each section of the agricultural area and the location of the agricultural machine

For example, the out of field transport rate of the harvest system may be such that the controller determines that a lower productivity index section of the field should be harvested. However, a section with a lower productivity index may be a significant distance away from the current position of the harvester, and the travel time to reach the lower productivity may be such that by the time the harvester reaches the lower productivity index section of the field, the availability of transport vehicles has changed, resulting in a desire to harvest a higher productivity index section of the field. In such case, it may be that the distance, and thus the travel time of the harvester, to a section of the agricultural area may be less desirable than to a different section of the agricultural area, even if the different section has a less desirable productivity index value.

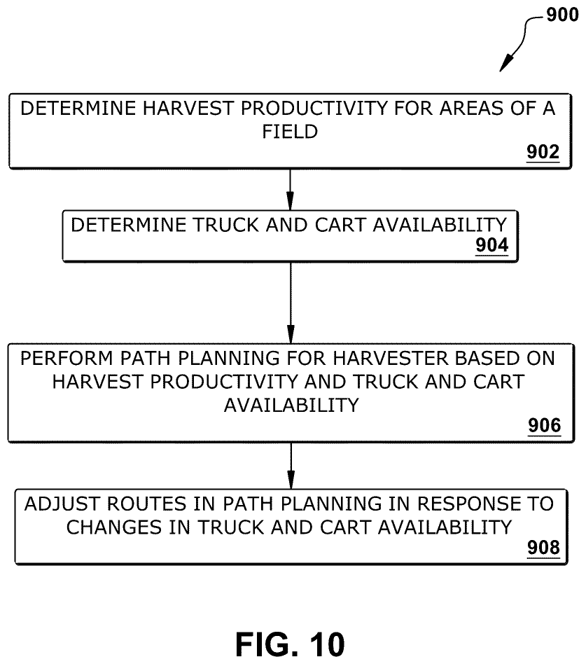

Using the determined area of productivity, in some examples, a method 900 as illustrated in FIG. 10 is performed to provide path planning for the agricultural machines, such as the harvester vehicles 100. For example, the controller 110 controls the agricultural machines along paths or routes to improve harvest productivity for the overall harvest system 102 using the method 900. In some examples, the method 900 includes determining a harvest productivity for area of the field 108. For example, lower and higher yield areas of the field 108 are determined at 902. The harvest productivity can be determined using different processes and methods as described in more detail herein, including using the PPI and/or the method 800 shown in FIG. 9.

The method 900 includes determining truck and cart availability at 904. For example, predictive and reactive determination of truck and cart availability are determined as described in more detail herein. The availability determination can be based on real-time, predicted, or in-situ data, as well as historical data regarding the harvest off-loading process for the field 108 and/or the harvest vehicles 100. In some examples, determining the truck and cart availability includes using historical data and in-situ data to determine truck and cart arrival times at one or more harvester vehicles. Other inputs and methods of determining truck and cart availability as described in more detail herein are also contemplated.

Path planning for the harvester vehicles is performed at 906. For example, path planning for a plurality of harvester vehicles is performed based on the determined harvest productivity and truck and cart availability. As described herein, one or more paths or routes for the harvester vehicles are defined, which may be provided with a predictive productivity map in various examples. The predictive productivity map planning thereby uses predicted productivity index values and truck and cart availability to determine routes or paths for the coordinated movement of the harvester vehicles.

The method 900 adjusts routes in the predictive productivity map planning in response to changes in one or more harvesting conditions or characteristics, such as changes in truck and cart availability. For example, based on changes in the timing of the availability of one or more trucks and carts, one or more harvester vehicles are rerouted to different areas of the field 108, such as to higher yield or lower yield areas.

Thus, one or more examples provide harvester vehicle path planning for the predictive productivity map based on different harvesting conditions and characteristics, such as predicted throughput and truck and cart availability.

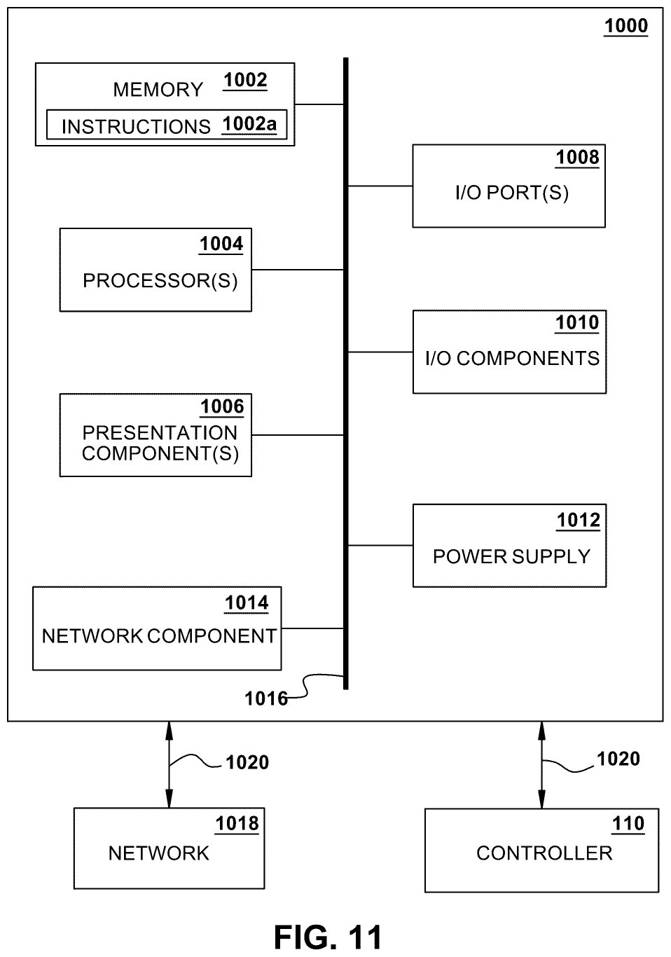

With reference now to FIG. 11, a block diagram of a computing device 1000 suitable for implementing various aspects of the disclosure as described. For example, in operation, the computing device 1000 is operable with the controller 110 to perform path planning for the predictive productivity map as described in more detail herein. FIG. 11 and the following discussion provide a brief, general description of a computing environment in/on which one or more or the implementations of one or more of the methods and/or system set forth herein may be implemented. The operating environment of FIG. 11 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, which perform particular tasks or implement particular abstract data types. Typically, the functionality of the computer readable instructions may be combined or distributed as desired in various environments.

In some examples, the computing device 1000 includes a memory 1002, one or more processors 1004, and one or more presentation components 1006. The disclosed examples associated with the computing device 1000 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 11 and the references herein to a “computing device.” The disclosed examples are also practiced in distributed computing environments, where tasks are performed by remote-processing devices that are linked through a communications network. Further, while the computing device 1000 is depicted as a single device, in one example, multiple computing devices work together and share the depicted device resources. For instance, in one example, the memory 1002 is distributed across multiple devices, the processor(s) 1004 provided are housed on different devices, and so on.

In one example, the memory 1002 includes any of the computer-readable media discussed herein. In one example, the memory 1002 is used to store and access instructions 1002a configured to carry out the various operations disclosed herein. In some examples, the memory 1002 includes computer storage media in the form of volatile and/or nonvolatile memory, removable or non-removable memory, data disks in virtual environments, or a combination thereof. In one example, the processor(s) 1004 includes any quantity of processing units that read data from various entities, such as the memory 1002 or input/output (I/O) components 1010. Specifically, the processor(s) 1004 are programmed to execute computer-executable instructions for implementing aspects of the disclosure. In one example, the instructions 1002a are performed by the processor 1004, by multiple processors within the computing device 1000, or by a processor external to the computing device 1000. In some examples, the processor(s) 1004 are programmed to execute instructions such as those illustrated in the flow charts discussed herein and depicted in the accompanying drawings.

In other implementations, the computing device 1000 may include additional features and/or functionality. For example, the computing device 1000 may also include additional storage (e.g., removable and/or non-removable) including, but not limited to, magnetic storage, optical storage, and the like. Such additional storage is illustrated in FIG. 11 by the memory 1002. In one implementation, computer readable instructions to implement one or more implementations provided herein may be in the memory 1002 as described herein. The memory 1002 may also store other computer readable instructions to implement an operating system, an application program and the like. Computer readable instructions may be loaded in the memory 1002 for execution by the processor(s) 1004, for example.

The presentation component(s) 1006 presents data indications to an operator or to another device. In one example, the presentation components 1006 include a display device, speaker, printing component, vibrating component, etc. One skilled in the art will understand and appreciate that computer data is presented in a number of ways, such as visually in a graphical user interface (GUI), audibly through speakers, wirelessly between the computing device 1000, across a wired connection, or in other ways. In one example, the presentation component(s) 1006 are not used when processes and operations are sufficiently automated that a need for human interaction is lessened or not needed. I/O ports 1008 allow the computing device 1000 to be logically coupled to other devices including the I/O components 1010, some of which is built in. Implementations of the I/O components 1010 include, for example but without limitation, a microphone, keyboard, mouse, joystick, pen, game pad, satellite dish, scanner, printer, wireless device, camera, etc.

The computing device 1000 includes a bus 1016 that directly or indirectly couples the following devices: the memory 1002, the one or more processors 1004, the one or more presentation components 1006, the input/output (I/O) ports 1008, the I/O components 1010, a power supply 1012, and a network component 1014. The computing device 1000 should not be interpreted as having any dependency or requirement related to any single component or combination of components illustrated therein. The bus 1016 represents one or more busses (such as an address bus, data bus, or a combination thereof). Although the various blocks of FIG. 11 are shown with lines for the sake of clarity, some implementations blur functionality over various different components described herein.

The components of the computing device 1000 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 1000 may be interconnected by a network. For example, the memory 1002 may be comprised of multiple physical memory units located in different physical locations interconnected by a network.

In some examples, the computing device 1000 is communicatively coupled to a network 1018 using the network component 1014. In some examples, the network component 1014 includes a network interface card and/or computer-executable instructions (e.g., a driver) for operating the network interface card. In one example, communication between the computing device 1000 and other devices occurs using any protocol or mechanism over a wired or wireless connection 1020. In some examples, the network component 1014 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 1020 may include, but is not limited to, a modem, a Network Interface Card (NIC), an integrated network interface, a radio frequency transmitter/receiver, an infrared port, a USB connection or other interfaces for connecting the computing device 1000 to other computing devices. The connection 1020 may transmit and/or receive communication media.

Although described in connection with the computing device 1000, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure arc implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically crasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A system for improving harvest production performance, the system comprising:
an agricultural harvester configured to harvest a crop; and
a controller comprising a processor for processing instructions and data, and memory for storing the instructions and the data, the controller configured to:
identify crop transport availability during a harvesting operation, wherein the crop transport availability comprises data representing an out of field transport system characteristic; and
identify a predictive harvesting path for the harvester based at least on the identified crop transport availability and a productivity index for at least a portion of a field in which the harvester is operating;
wherein the productivity index for the at least the portion of the field is representative of a predicted harvest rate for the crop in a location in the field; and
wherein the predictive harvesting path is used to guide the harvester to an area of the field that will provide the improved harvest production performance.

2. The system of claim 1, wherein the out of field transport system characteristic comprises an availability of a grain cart to receive the harvested crop from the harvester, the grain cart availability comprising a current availability and a predicted availability.

3. The system of claim 1, wherein the out of field transport system characteristic comprises an availability of a grain truck transport to receive the harvested crop from a grain cart, the grain truck availability comprising a current availability and a predicted availability.

4. The system of claim 1, wherein the out of field transport system characteristic comprises a status of the transport system, the status comprising one or more of:
time for transporting the harvested crop transport off site;
time for grain truck availability after unloading of harvested crop off site;
a wait time at harvested crop unloading site; and
identified off site traffic impacts.

5. The system of claim 1, wherein the out of field transport system characteristic comprises a rate of transport of the harvested crop off site.

6. The system of claim 1, wherein the out of field transport system characteristic comprises a rate of transport by a grain cart of the harvested crop from the harvester to a grain transport truck.

7. The system of claim 1, wherein the predicted harvest rate for the crop in a location in the field comprises an amount of harvested crop over an area, or amount of harvested crop over a period of time.

8. The system of claim 1, wherein the predicted harvest rate for the crop in a location in the field comprises a mass of harvested crop per area or time, or volume of harvested crop per area or time.

9. The system of claim 1, wherein the predictive harvesting path comprises a location in the field with a lower productivity index when the identified crop transport availability is lower, and the predictive harvesting path comprises a location in the field with a higher productivity index when the identified crop transport availability is higher.

10. The system of claim 1, comprising a mapping subsystem that generates a field map to guide the harvester based on the predictive harvesting path.

11. The system of claim 10, comprising a user display that displays the generated field map to an operator of the harvester.

12. The system of claim 1, comprising a harvester control subsystem that controls the harvester based on the predictive harvesting path.

13. The system of claim 12, the harvester control subsystem comprising one or more of: a harvester propulsion control and a harvester steering control.

14. A computer-based system for improving harvest production performance, the system comprising a processor for processing instructions and data, and memory for storing the instructions and the data, the system further comprising:
a crop transport logistics module that identifies crop transport availability for a harvesting operation performed by at least one harvester in a field, wherein the crop transport availability is identified using data representative of the availability of one or more crop transport vehicles to offload harvested crop from the harvester during the harvesting operation;
a harvester operation mapping module that identifies a harvesting path for the harvester during the operation to provide a predicted crop harvesting rate that complements the identified crop transport availability, the harvesting path for the harvester identified using a productivity index for at least a portion of a field, wherein the productivity index is representative of a predicted harvest rate for the crop in a location in the field; and
a harvester control module that guides the harvester to an area of the field that will provide the improved harvest production performance.

15. The system of claim 14, wherein the identified harvesting path for the harvester comprises a location in the field with a lower productivity index when the identified crop transport availability is lower, and the identified harvesting path for the harvester comprises a location in the field with a higher productivity index when the identified crop transport availability is higher.

16. The system of claim 14, wherein the identified crop transport availability comprises an availability of a grain cart to receive the harvested crop from the harvester, the grain cart availability comprising a current availability and a predicted availability.

17. The system of claim 14, wherein the identified crop transport availability comprises an availability of a grain truck transport to receive the harvested crop from a grain cart, the grain truck availability comprising a current availability and a predicted availability.

18. The system of claim 14, wherein the identified harvesting path for the harvester is used by a mapping subsystem that generates a field map to guide the harvester based on identified harvesting path.

19. The system of claim 14, comprising a harvester control subsystem that controls the harvester based on the identified harvesting path, the harvester control subsystem comprising one or more of: a harvester propulsion control and a harvester steering control.

20. A system for improving harvest production performance, the system comprising:
an agricultural harvester configured to harvest a crop in a field during a harvesting operation;
a controller comprising a processor for processing instructions and data, and memory for storing the instructions and the data, the controller configured to:
identify crop transport availability during a harvesting operation, wherein the crop transport availability comprises data representing an out of field transport system characteristic; and
identify a predictive harvesting path for the harvester based at least on the identified crop transport availability and a productivity index for at least a portion of a field in which the harvester is operating; and
a harvester control module that guides the harvester to an area of the field that will provide the improved harvest production performance using the predictive harvesting path for the harvester, the harvester control module comprising one or more of:
a mapping subsystem that generates a field map to guide the harvester based on the predictive harvesting path; and
a harvester control subsystem that controls the harvester based on the predictive harvesting path;
wherein the productivity index for the at least the portion of the field is representative of a predicted harvest rate for the crop in a location in the field; and
wherein the predictive harvesting path comprises a location in the field with a lower productivity index when the identified crop transport availability is lower, and the predictive harvesting path comprises a location in the field with a higher productivity index when the identified crop transport availability is higher.
